(19) United States
(12) Patent Application Publication
(10) Pub. No.: US 2025/0242839 A1
(43) Pub. Date: Jul. 31, 2025

(54) People transportation carrier, cable transportation installation

(71) Applicant: Sigma Composite, Les Avenieres Veyrins-Thuellin (FR)

(72) Inventors: Vincent LIENARD, Les Avenieres Veyrins-Thuellin (FR); Ludovic SUCHET, Les Avenieres Veyrins-Thuellin (FR); Quentin VERNUS, Les Avenieres Veyrins-Thuellin (FR)

(73) Assignee: Sigma Composite, Les Avenieres Veyrins-Thuellin (FR)

(21) Appl. No.: 19/041,492

(22) Filed: Jan. 30, 2025

(30) Foreign Application Priority Data
Jan. 30, 2024 (FR) 2400918

(51) Int. Cl. B61B 12/00; A62B 35/00; B61B 7/02

(52) U.S. Cl. CPC B61B 12/002; B61B 7/02; A62B 35/0006; A62B 35/0043

(57) ABSTRACT

A cable transportation carrier for transporting people includes a connector designed to be attached to an aerial cable. A frame is fixed to the connector and defines a permanent opening onto the outside. An anchor point is provided and is designed to attach a person equipped with a safety harness with a safety connector. The anchor point defines a blocking state and a free state. In the blocking state, the safety connector cannot leave the anchor point. In the free state, the safety connector can leave the anchor point. A locking device presents a locked state and an unlocked state. In the locked state, the locking device keeps the anchor point in the blocking state. In the unlocked state, the locking device allows the anchor point to switch between the blocking state and the free state.

### BACKGROUND OF THE INVENTION

The invention relates to a people transportation carrier, to a transportation assembly and to a people transportation carrier installation comprising one such assembly.

### PRIOR ART

In conventional manner, a cable transportation installation comprises two terminal stations connected to one another by a carrying cable to which carrier vehicles are attached. The cable moves enabling people to be transported between several stations. To achieve an increasingly efficient transportation under optimum safety conditions, it is conventional to use gondola cars attached to the hauling cable by detachable grips thereby enabling loading and unloading to be performed at reduced speed and travel to take place at a much higher speed. To procure optimum comfort, the gondola cars are protected from external conditions and safety is achieved by providing for the loading and unloading doors not to be able to be opened en route. It is possible to have heated gondola cars to enhance comfort during travel for the greatest satisfaction of a larger proportion of the passengers. The cars define a closed volume almost without any opening to keep the users within a reduced and controlled volume.

On the other hand, a fringe of the population is seeking to experience strong sensations. The latter use zip lines and slide along a cable at high speeds. The sensation of speed is accentuated with the wind that hits their faces and the possibility of observing the ground running past under their bodies. Under substantially the same conditions, gondola cars do not procure such sensations in particular due to their fairing.

It was observed that maintenance vehicles that are not provided with fairing have the effect of procuring more sensations for their users as the fairing is virtually non-existent. The passengers then experience more pronounced sensations of speed and void. Maintenance vehicles are however reserved for highly qualified personnel specially trained to always be in safe conditions on the maintenance vehicle and during the associated maintenance operation.

### OBJECT OF THE INVENTION

One object of the invention consists in providing a simple and efficient means for taking advantage of a cable transportation installation to provide more pronounced sensations of speed and void while preserving a high safety level.

This issue tends to be solved by means of a cable transportation carrier for transporting people comprising:
a connector designed to be attached to at least one aerial cable;
a frame fixed to the connector, the frame defining at least one permanent opening onto the outside;
at least one anchor point designed to attach a person equipped with a safety harness having a safety connector.

The carrier is remarkable in that:
the anchor point defines a blocking state and a free state, wherein in the blocking state, the safety connector cannot leave the anchor point, and in the free state, the safety connector is able to leave the anchor point;
a locking device presenting a locked state and an unlocked state, wherein in the locked state, the locking device keeps the anchor point in the blocking state and wherein in the unlocked state, the locking device allows the anchor point to switch between the blocking state and the free state.

In advantageous manner, the frame is provided with at least one rail extending from an access opening, the rail forming a part of the anchor point. A shutter is fitted movable between an open position and a closed position. The shutter in the closed position limits the travel of the safety connector, the closed position of the shutter corresponding to the blocking state of the anchor point. The open position of the shutter allows free movement of the safety connector along the rail.

In a particular configuration, the rail is attached to a ceiling of the frame.

Preferentially, the cable transportation carrier comprises at least one door installed movable between an entry-exit position and a transportation position, in the entry-exit position the door enables people to board the frame and to disembark from the frame. In the transportation position, the door prevents the locking device from being shifted from the locked state.

According to one embodiment, the frame is provided with at least one door installed movable between an entry-exit position and a transportation position, in the entry-exit position the door enables people to board the frame and to disembark from the frame. The locking device in the unlocked state prevents the door from being moved from the entry-exit position to the transportation position.

In preferential manner, the locking device is provided with a lever installed movable between an unlocked position and a locked position. In the locked position, the lever prevents the door from reaching the transportation position, the locked position of the lever corresponding to the locked position of the locking device and the unlocked position of the lever corresponding to the unlocked position of the locking device.

Advantageously, the connector is a detachable connector presenting an attached position where a grip is attached to at least one hauling cable and a detached position where the grip is detached from the at least one hauling cable. The at least one anchor point is functionally connected to a warning device configured to allow or prevent attachment of the detachable connector with the at least one hauling cable. When the anchor point is in the free state, the warning device prevents attachment of the detachable connector with the at least one hauling cable. When the anchor point is in the blocking state, the warning device allows attachment of the detachable connector with the at least one hauling cable.

Another object of the invention is to provide a transportation assembly that enables users to be transported in safety while providing them with greater sensations of speed and void.

This result tends to be achieved by means of a transportation assembly comprising a cable transportation carrier according to any one of the foregoing configurations and a safety harness provided with a lanyard presenting a first length. The lanyard is installed in a central position of the frame and the first length is smaller than the distance between the attachment point and each permanent opening of the at least one permanent opening.

In a particular embodiment, the first length is smaller than the distance between the attachment point and each permanent opening of the at least one permanent opening by at least 1 metre.

One object of the invention is also to provide a cable transportation installation that is able to transport users in safety while providing them with greater sensations of speed and void.

This result tends to be achieved by means of a cable transportation installation designed for transportation of people and comprising:
at least two terminals each provided with a bull-wheel;
at least one aerial cable provided with at least one hauling cable and at least one carrying cable, the at least one hauling cable operating in conjunction with the bull-wheels;
a motor driving at least one of the bull-wheels in rotation to move the at least one carrying cable;
at least one assembly according to one of the foregoing configurations.

Advantageously, the cable transportation installation according to the foregoing configuration comprises other carrier chosen from chairs and gondola cars.

It is a further object of the invention to provide an operating method of a cable transportation installation that ensures the safety of a user in a carrier comprising apertures.

This result tends to be achieved by means of an operating method of the cable transportation installation that comprises the following steps:
providing a cable transportation installation according to one of the foregoing configurations;
providing a carrier provided with an anchor point and at least one through opening;
placing the carrier in a loading area of a station, the carrier having an anchor point in a free state;
having at least one user wearing a safety harness enter the carrier and attach the safety connector to the anchor point;
changing the state of the anchor point to have an anchor point in the blocking state;
moving the carrier so that the carrier leaves the station.

### BRIEF DESCRIPTION OF THE DRAWINGS

Other advantages and features will become more clearly apparent from the following description of particular embodiments and implementation modes of the invention given for non-restrictive example purposes only and represented in the appended drawings, in which:

FIG. 1 schematically illustrates a view of a cable transportation installation;

FIG. 2 schematically illustrates a perspective view of a frame of a cable transportation installation;

FIG. 3 schematically illustrates a side view of a frame of a cable transportation installation;

FIG. 4 schematically illustrates a front view of a frame of a cable transportation installation, the doors being in an open position;

FIG. 5 schematically illustrates a side view of a rail designed to be fixed to a ceiling of a frame, the shutter being in an open position;

FIG. 6 schematically illustrates a side view of a rail designed to be fixed to a ceiling of a frame, the shutter being in a closed position;

FIG. 7 schematically illustrates a perspective view of a rail designed to be fixed to a ceiling of a frame, the shutter being in an open position;

FIG. 8 schematically illustrates a perspective view of a rail designed to be fixed to a ceiling of a frame, the shutter being in a closed position.

### DESCRIPTION OF THE EMBODIMENTS

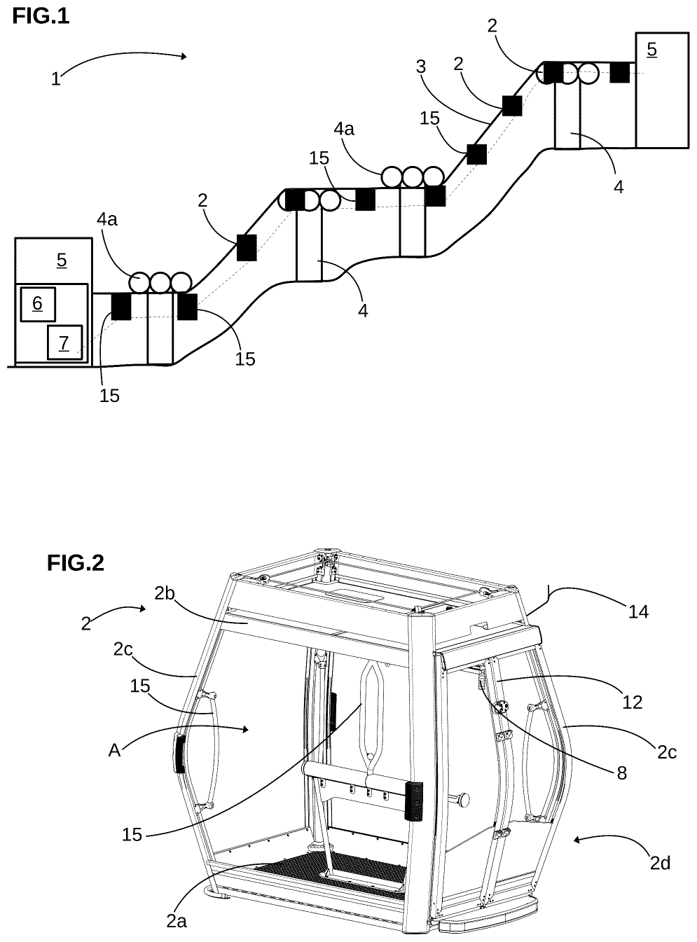

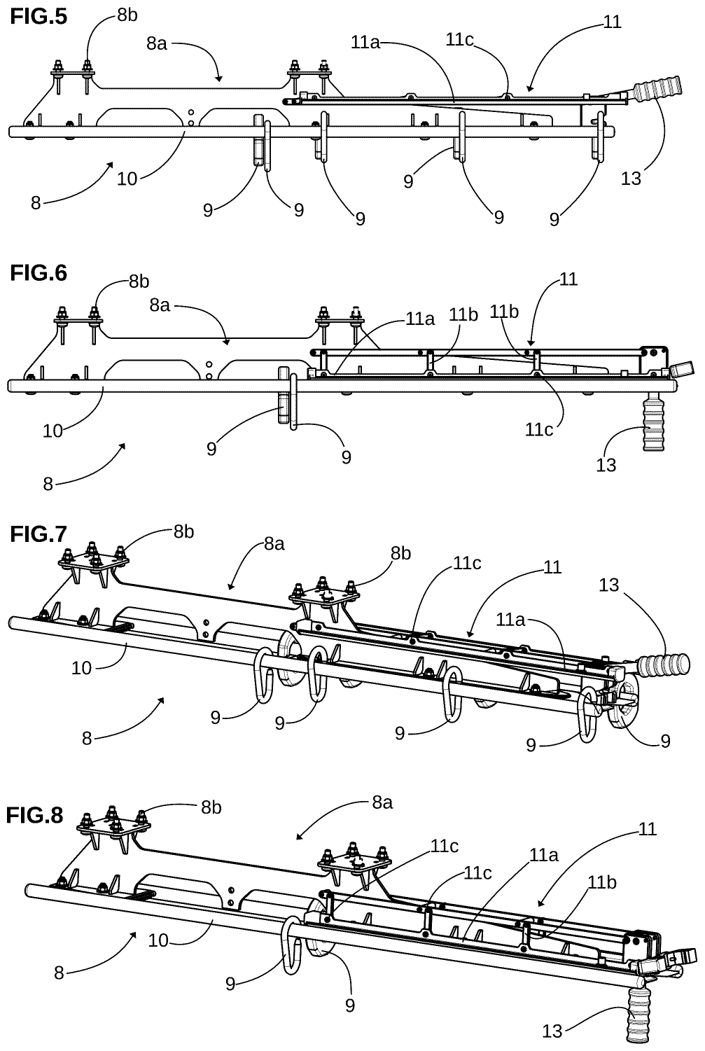

FIGS. 1 to 4 illustrate different embodiments of a cable transportation installation 1 and of a carrier 2 of a cable transportation installation 1. FIGS. 5 to 8 illustrate different states of a rail designed for attaching users of frame 2.

The cable transportation installation 1 comprises an aerial cable 3. What is meant by an aerial cable 3 is at least one aerial cable 3. The at least one aerial cable 3 comprises a carrying cable and a hauling cable. What is meant by a carrying cable and a hauling cable is at least one carrying cable and at least one hauling cable.

The cable transportation installation 1 can comprise a single aerial cable 3 that is a carrying and hauling cable. The cable transportation installation 1 can comprise two aerial cables 3 or more. The two aerial cables 3 can be two carrying and hauling cables. The cable transportation installation 1 can comprise hauling cables and carrying cables that are distinct from one another. The cable transportation installation 1 can comprise more carrying cables than hauling cables, for example two carrying cables and one hauling cable.

The cable transportation installation 1 can comprise pillars 4 that are equipped with sheaves 4a designed to support the aerial cable 3.

The cable transportation installation 1 comprises two terminals 5 that are each equipped with a bull-wheel. At least one of the bull-wheels is associated with a drive device 6 that is configured to make the bull-wheel rotate and to perform driving of the hauling cable. The drive device 6 is equipped with at least one motor. The cable transportation installation 1 is equipped with a control circuit 7.

The cable transportation installation 1 comprises at least one carrier 2 that is attached to the aerial cable 3 by a connector. The connector performs attachment to the hauling cable and also support of the carrier 2 by the carrying cable. The connector can be a conventional connector, for example a detachable connector that is able to be attached and detached to/from the aerial cable 3 or a fixed connector that is always attached to the aerial cable 3.

The carrier 2 is designed to support or suspend one or more users. The carrier 2 can comprise a frame provided with a floor 2a and/or a ceiling 2b. The frame can comprise one or more uprights 2c. The carrier 2 defines an anchor point 8. To provide the users with heightened sensations, in particular a greater sensation of speed and a greater apprehension of heights, the carrier 2 defines one or more apertured areas that are permanent openings A between the inside of the carrier 2 and the outside of the carrier 2. The permanent openings A are openings designed to allow a person to move between the inside and the outside, for example a section larger than 50×50 cm² or larger than 80×80 cm². It is advantageous for an opening to extend from the floor 2a to the ceiling 2b. As the carrier 2 is highly apertured, the user is able to have a better view over the panorama offered during the travel and with a better appreciation of the distance separating the latter from the ground.

Such openings give rise to safety problems as a person is able to leave the carrier 2 which is prejudicial when the carrier 2 is moving and/or when it is outside a terminal.

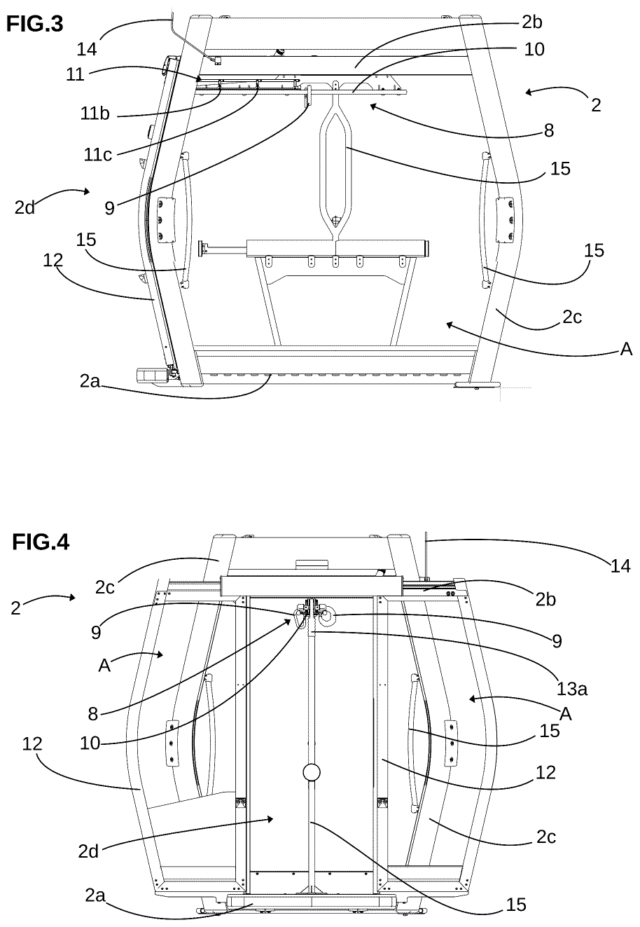

To ensure the safety of a person installed in the carrier, it is important to provide an anchor point 8 that will enable the user to be attached to the carrier 2. The user wears a safety harness that is attached to the anchor point 8. The roping harness is equipped with a safety connector 9 that operates in conjunction with the anchor point 8 to attach the user to the carrier 2 during movement of the carrier 2. FIGS. 3 to 8 illustrate safety connectors 9 having different forms.

Preferentially, the safety connector 9 is a ring. What is meant by a ring is a closed structure that defines at least one through hole. It also means a body having a C-shape or another shape that extends away from the closed structure defining a slot of small width as illustrated in FIG. 4. The width is sufficiently small not to allow the anchor point 8 to leave an area provided for this purpose. The safety connector 9 can be a ring of circular or oval shape. It is also possible for the safety connector 9 to be generally of circular or oval shape and to define a slot of small width.

To improve user safety, the roping harness has a safety connector 9 that is non-openable. It is also important for the user not to be able to disconnect himself from the anchor point 8. It is therefore particularly advantageous to provide for the anchor point 8 to define a blocking state and a free state. In the blocking state, the safety connector 9 cannot leave the anchor point 8 and more preferentially cannot leave a predefined area 8a of the anchor point 8. In the free state, the safety connector 9 can move out of the predefined area 8a and can leave the anchor point 8.

In the blocking state, confinement of the safety connector 9 in a particular area can be achieved by different means. For example, to block the safety connector 9 in the predefined area 8a, it is possible to close the anchor point 8 to define a closed or almost closed ring. It is further possible to install a movable or removable shutter that blocks the entry hole of the anchor point 8. It is also possible to use a magnetic device that blocks the safety connector or connectors 9 in the predefined area 8a provided that the safety connectors 9 are magnetizable.

Preferentially, the anchor point 8 is an openable anchor point. The anchor point 8 has a movable portion to define an open position and a closed position. The open position allows the safety connector 9 to be inserted and extracted. The closed position prevents extraction of the safety connector 9.

FIGS. 2, 3, 4, 6 and 8 illustrate an anchor point 8 in the closed position. FIGS. 5 and 7 illustrate an anchor point 8 in the open position.

The anchor point 8 is formed in two or more parts at least one part of which is movable with respect to the others to define the open position and the closed position. In particularly advantageous manner, in the open position, the anchor point 8 defines a hook. To secure the safety connector 9 firmly with the carrier 2, one end of the hook passes through one of the through holes of the safety connector 9.

The anchor point 8 is mounted in fixed manner on the carrier 2, preferably on the ceiling 2b.

Once the safety connector 9 has been fixed to the anchor point 8 and anchor point 8 is in the closed position, the user is attached to the carrier 2 thereby preventing him from accidentally falling from the carrier 2. The use of an anchor point 8 in the closed position prevents a wrong action from being performed on an openable safety connector 9 that could lead to a user being able to move freely in the carrier 2 and outside the carrier 2. It is advantageous to have a safety connector 9 that is non-openable or non-openable by the user. The safety connector 9 can be a connector intended for “adventure parks” secured to a lifeline with the possibility of detaching oneself only at the ends of the lifeline.

Preferentially, the anchor point 8 is configured to be non-openable by the user attached to the anchor point 8.

In particularly advantageous manner, the anchor point 8 is in the closed position when the carrier 2 is attached to the hauling cable. Attachment to the hauling cable means that the carrier 2 is located between the terminals 5, i.e. that the carrier 2 can be at a great height with respect to the ground or that the carrier 2 is liable to leave the terminal 5 or to move in the terminal 5 at high speed. In all cases, it is important for the user to be securely attached to the carrier 2. The roping harness has a lanyard that is terminated by the safety connector 9. The length of the lanyard is chosen such that the user is not able to leave the carrier 2. More preferentially, the length of the lanyard is chosen such that the user is not able to pass one of his limbs through one of permanent openings A.

In a particularly advantageous embodiment, the anchor point 8 is located in a central portion of the carrier 2. Installing the latter in the central portion makes it possible to have a length of lanyard that offers maximum access to the inner volume of the carrier 2. For example purposes, the length of the lanyard is less than or equal to 1 metre.

In preferential manner, the anchor point 8 is located in the top half of the carrier 2, in the vertical direction of the carrier 2 in use.

In a preferential embodiment illustrated in FIGS. 2 to 4, the carrier 2 is provided with at least one rail 10 extending from an access opening 2d of the carrier 2. The access opening 2d is the opening via which the user or users are invited to enter and exit the carrier 2. The rail 10 forms a part of the anchor point 8.

The movable part of the anchor point 8 can be a shutter 11 installed movable between a blocking position and a release position. In the blocking position, the shutter 11 limits the movement of the safety connector 9. The blocking position of the shutter 11 corresponds to the closed position of the at least one anchor point 8. The open position of the shutter 11 allows the safety connector 9 to move freely along the rail 10.

Preferentially, the rail 10 is fixed to the ceiling 2b of the carrier 2. On entering the carrier 2 via the access opening 2d, the user or a third party connects the safety connector 9 to the rail 10 that forms a part of the anchor point 8. The use of a rail 10 that extends up to the access opening 2d enables an operator in charge of safety to check whether the user or users are connected to the rail 10 as soon as they enter the carrier 2. This embodiment is more efficient than an alternative configuration where the rail 10 is only present in the central part of the carrier 2. This configuration forces the operator to check that each of the users is attached when switching to the blocking state of the anchor point 8 which may make it necessary to enter the carrier 2 if the latter is cramped.

It is particularly advantageous for the rail 10 to be fixed to the ceiling 2b as this enables a quick check to be made of the number of safety connectors 9 that are connected to the rail 10 to check that each user is connected to the carrier 2. It is particularly advantageous for the rail 10 to only provide a single end able to perform attachment and detachment with a safety connector 9. In this way, only this end has to be checked by the operator to ensure that each user is attached to the rail 10.

Depending on the embodiments, the rail 10 can be a salient part or a slot. FIGS. 2 to 8 illustrate a rail 10 presented in the form of a rod attached to the carrier 2. The rod can have any cross-section. In an alternative embodiment, the rail 10 can be a slot that extends for example in the panel of the ceiling 2b. The safety connector 9 is inserted in the slot and remains firmly secured to the slot. Other configurations are possible.

In particularly advantageous manner, the carrier 2 is provided with a locking device that presents a locked position and an unlocked position. In the locked position, the locking device prevents a change of state of the anchor point 8 from the closed position to the open position. In the unlocked position, the locking device allows a change of state of the anchor point 8 from the closed position to the open position. In preferential manner, the anchor point 8 in the open position prevents movement of the locking device from the unlocked position to the locked position.

In preferential manner, the carrier 2 is provided with at least one door 12 installed movable between an entry-exit position and a transportation position. In the entry-exit position, the door 12 moves away from the access area 2d to facilitate loading of people in the carrier 2 and unloading of people from the carrier 2. In the transportation position, the door 12 covers the access area 2d to make movement through the access area 2d more complicated. When the door 12 is apertured, it may be unable to prevent entry into or exit from the carrier 2. What is meant by the door 12 is one or more doors.

It is advantageous to use the door 12 as locking device. In the entry-exit position, the door 12 enables a change of state of the anchor point 8 from the closed position to the open position. In the transportation position, the door 12 prevents a change of state of the anchor point 8 from the closed position to the open position.

In an advantageous embodiment, the carrier 2 is substantially in the form of a carrier vehicle or of a framework of a car of a gondola lift installation. The carrier 2 can be devoid of windows that are used to protect the user against wind and bad weather. The gondola car is conventionally provided with one or more doors. The carrier 2 is provided with one or more doors that can define one or more through openings. When the door is provided with a through opening, it is unable to prevent a user from entering the carrier or from exiting the carrier, the door not being able to act in the same way as a gondola car door.

As the gondola cars are provided with doors and the doors are associated with detection devices, it is advantageous to provide for the carrier 2 to be provided with the same doors configured to operate with the detection devices of the cable transportation installation 1. The detection devices are configured to detect whether the doors are in an open state or in a closed state. Depending on the detected state, the detection device can allow or prevent exit from the carrier vehicle when outside the terminal, for example the detection device can allow or prevent coupling of the connector with the hauling cable. The detection device can also transmit a first signal to control circuit 7 that controls movement of the carrier or carriers in the terminal 5 and possibly driving of the hauling cable.

It is possible to provide a cable transportation installation 1 equipped with gondola cars and to replace one or more cars by one or more carriers 2. The cars and carriers preferentially present identical volumes. This enables a carrier 2 to be used instead of a gondola car in an installation of gondola lift type without having to modify the rest of the installation.

The use of the door 12 as locking device configured to prevent opening of the anchor point 8 in the form of a ring so long as the door 12 is in the transportation position is particularly advantageous to ensure safety. When the carrier 2 is attached to the hauling cable, it is advantageous to prevent opening of the doors 12. Consequently, so long as the carrier 2 is able to move at high speed, the door 12 is in the transportation position and the user is connected to the carrier 2.

It is also advantageous for opening of the door 12 to allow opening of the anchor point 8 and to impose an additional step to achieve opening of the anchor point 8. In a particular embodiment, the anchor point 8 is provided with a lever 13 fitted movable between an open position and a closed position. FIGS. 2, 3, 4, 6 and 8 illustrate a lever 13 in the closed position. FIGS. 5 and 7 illustrate a lever 13 in the open position.

In the open position, the lever 13 prevents the door 12 from reaching the transportation position. In the open position, the lever 13 forms an obstacle on the travel path of the door 12.

In the illustrated embodiment, the carrier 2 is provided with two doors 12 that move towards one another when leaving the open position to reach the closed position or that move away from one another when leaving the closed position to reach the open position. It is advantageous, in the open position, for the lever 13 forming a handle to prevent the two doors 12 from reaching the closed position. A similar operating manner can be obtained with a carrier 2 provided with a single door 12 or with more than two doors 12. The lever 13 is arranged in such a way that, in the unlocked position, the lever 13 prevents the door 12 or at least one of the doors 12 from reaching the closed position.

In an advantageous embodiment, the connector is a detachable connector presenting an engaged position where the connector is attached to at least one hauling cable and a detached position where the connector is disconnected from the at least one hauling cable. The anchor point 8 is functionally connected to a warning device 14 configured to allow or prevent attachment of the detachable connector with the at least one hauling cable. When the anchor point 8 is in the open position, the door or doors 12 cannot be in the transportation position. The warning device 14 is in a position that prevents attachment of the detachable connector with the at least one hauling cable. When the door or doors 12 are in the transportation position, this implies that the anchor point 8 is in the closed position and the warning device 14 is in a position that enables attachment of the detachable connector with the at least one hauling cable.

As an alternative, the warning device 14 is connected to the door 12 or to one of the doors 12 so that the door 12 outside the closed position corresponds to a warning device 14 representative of attachment to the hauling cable being prevented.

The warning device 14 is for example a rod fitted movable in translation or swivelling with respect to the carrier 2. The warning device 14 is fitted movable between a position allowing attachment to the hauling cable and a position preventing attachment to the hauling cable.

These embodiments are particularly advantageous when the carrier 2 is used in a cable transportation installation 1 designed for transporting gondola cars 15 in which the gondola cars 15 use the same configuration of the warning device 14 according to the position of the door or doors. More particularly, the carrier 2 is used in a cable transportation installation 1 that also performs transportation of the gondola cars 15. In other words, the hauling cable is used to haul one or more gondola cars 15 and also one or more carriers 2. The carrier or carriers can be replaced by a chair or chairs or a mix between gondola cars and chairs.

In a known operating mode, one or more users place themselves in a loading area of a terminal 5 so as to be facing an access area of a gondola car 15 when the door or doors of the gondola car 15 are opened. The users enter the gondola car 15 and the doors are reclosed before the gondola car 15 leaves the terminal 5. Once the doors have been closed, the users are installed in a closed vehicle that prevents a user from leaving the carrier 2. The operator and/or control circuit 7 of the installation check that the doors are closed and that no user is outside the loading area.

Installation of the users in a carrier 2 corresponds to a different issue. As the carrier 2 is open onto the outside with openings that are not able to prevent a user from getting out of the frame, it has to be ensured that the users will not be able to leave the carrier 2 before the carrier 2 has left the terminal 5.

It is therefore particularly advantageous for the users to be attached to the carrier 2 rapidly, preferably as soon as they enter the volume defined by the carrier 2. Secondly, the anchor point 8 is preferentially closed by means of a shutter 11 that limits the movement of the safety connectors 9 and/or that closes off the anchor point 8.

The operator in charge of safety is able to check quickly that each of the users attaches his safety connector 9 to the anchor point 8 or is able to attach the safety connectors 9 to the anchor point 8 and to then close the anchor point 8 or to limit the authorised area for movement of the safety connectors 9 being sure that no user is disconnected from the anchor point 8. The safety operator does not need to enter the carrier 2 which results in a time saving and enhanced safety.

In preferential manner, the floor 2a of the carrier is an apertured part, for example a grating or screening. As an alternative, the floor 2a of the carrier 2 is a transparent glass panel.

The carrier 2 can be provided with gripping means 16 that enable the user to grasp them to have a better stability when the carrier 2 is moving.

In the preferential embodiment illustrated in FIGS. 4 to 8, the shutter 11 is a part fitted movable with respect to the rail 10 to present a first position enabling a safety connector 9 to be connected and a second position preventing the safety connector 9 from being disconnected. The shutter 11 is installed in pivotable manner. In the open position, the shutter 11 is installed at a distance from the rail 10 to enable the safety connector or connectors 9 to be moved between the rail 10 and the shutter 11. In the closed position, the shutter 11 is in contact with the rail 10 or almost in contact with the rail 10. The assembly formed by the rail 10 and the shutter 11 presents a larger cross-section than the cross-section of the through hole defined by the safety connector 9 that is no longer able to escape from the rail 10. By choosing the position of the facing between the rail 10 and shutter 11, the limit of the area where the safety connector 9 can move during movement of the carrier 2 is defined.

Preferentially, the shutter 11 is in contact or almost in contact with the rail 10 from the end of the rail 10 to the end of the authorised area for movement of the safety connector 9. This configuration makes it possible to quickly detect if a safety connector 9 is outside the authorised movement area when the shutter 11 moves to the closed position.

In an advantageous embodiment, the shutter 11 has a plate 11a installed in fixed manner with respect to the carrier 2. The plate 11a is movable with respect to the carrier 2 by means of several pivotally-mounted arms 11b. The shutter 11 is equipped with pivot shafts 11c.

The anchor point 8 is fixed to the carrier 2 by attachment means for example nuts and bolts 8b.

An operating method of the cable transportation installation 1 can comprise the following steps:
providing a cable transportation installation 1 as described in the foregoing;
providing a carrier 2 provided with an anchor point 8 and at least one through opening 9;
placing the carrier 2 in a loading area of a terminal 5, the carrier 2 having an anchor point 8 in a free state;
having at least one user wearing a safety harness enter the carrier 2 and attach the safety connector 9 to the anchor point 8;
changing the state of the anchor point 8 to have an anchor point 8 in the blocking state;
moving the carrier 2 so that the carrier 2 leaves the terminal 5.

1. Cable transportation carrier for transporting people comprising:
a connector designed to be attached to at least one aerial cable;
a frame fixed to the connector, the frame defining at least one permanent opening onto the outside;
at least one anchor point designed to attach a person equipped with a safety harness having a safety connector;
characterized in that the anchor point defines a blocking state and a free state, wherein in the blocking state, the safety connector cannot leave the anchor point and in the free state, the safety connectoris able to leave the anchor point;
a locking device presenting a locked state and an unlocked state, wherein in the locked state, the locking device keeps the anchor point in the blocking state, and wherein in the unlocked state, the locking device allows the anchor point to switch between the blocking state and the free state.

2. Cable transportation carrier according to claim 1, wherein the frame is provided with at least one rail extending from an access opening, the rail forming a part of the anchor point and wherein a shutter is fitted movable between an open position and a closed position, wherein the shutter in the closed position limits movement of the safety connector, the closed position of the shutter corresponding to the blocking state of the anchor point and wherein the open position of the shutter allows free movement of the safety connector along the rail.

3. Cable transportation carrier according to claim 1, wherein the rail is attached to a ceiling of the frame.

4. Cable transportation carrier according to claim 1, comprising at least one door installed movable between an entry-exit position and a transportation position, in the entry-exit position the door enables people to board the frame and to disembark from the frame, and wherein in the transportation position, the door prevents the locking device from being shifted from the locked state.

5. Cable transportation carrier according to claim 1, wherein the frame is provided with at least one door installed movable between an entry-exit position and a transportation position, in the entry-exit position the door enables people to board the frame and to disembark from the frame, wherein the locking device in the unlocked state prevents movement of the door from the entry-exit position to the transportation position.

6. Cable transportation carrier according to claim 1, wherein the locking device is provided with a lever installed movable between an unlocked position and a locked position, wherein in the locked position the lever prevents the door from reaching the transportation position, the locked position of the lever corresponding to the locked position of the locking device and the unlocked position of the lever corresponding to the unlocked position of the locking device.

7. Cable transportation carrier according to claim 1, wherein the connector is a detachable connector presenting an attached position where a grip is attached to at least one hauling cable and a detached position where the grip is disconnected from the at least one hauling cable, wherein the at least one anchor point is functionally connected to a warning device configured to allow or prevent attachment of the detachable connector with the at least one hauling cable, wherein when the anchor point is in the free state, the warning device prevents attachment of the detachable connector with the at least one hauling cable and wherein when the anchor point is in the blocking state, the warning device enables attachment of the detachable connector with the at least one hauling cable.

8. Transportation assembly comprising a cable transportation carrier according to claim 1 and a safety harness provided with a lanyard presenting a first length, wherein the lanyard is installed in a central position of the frame and the first length is smaller than the distance between the anchor point and each permanent opening of the at least one permanent opening.

9. Transportation assembly according to claim 8, the first length being smaller than the distance between the anchor point and each permanent opening of the at least one permanent opening by at least 1 metre.

10. Cable transportation installation designed for transporting people and comprising:
at least two terminals each provided with a bull-wheel;
at least one aerial cable provided with at least one hauling cable and at least one carrying cable, the at least one hauling cable operating in conjunction with the bull-wheels;
a motor driving at least one of the bull-wheels in rotation to move the at least one carrying cable;
at least one assembly according to claim 8.

11. Cable transportation installation according to claim 1 comprising other carrier vehicles chosen from chairs and gondola cars.
